(19) United States
(12) Patent Application Publication
(10) Pub. No.: US 2024/0256850 A1
(43) Pub. Date: Aug. 1, 2024

(54) NEURAL NETWORK INFERENCE UNDER HOMOMORPHIC ENCRYPTION

(71) Applicant: International Business Machines Corporation, Armonk, NY (US)

(72) Inventors: Omri Soceanu, Haifa (IL); Nir Drucker, Zichron Yaakov (IL); Subhankar Pal, White Plains, NY (US); Roman Vaculin, Larchmont, NY (US); Kanthi Sarpatwar, Briarcliff Manor, NY (US); Alper Buyuktosunoglu, White Plains, NY (US); Pradip Bose, Yorktown Heights, NY (US); Hayim Shaul, Kfar Saba (IL); Ehud Aharoni, Kfar Saba (IL); James Thomas Rayfield, Ridgefield, CT (US)

(73) Assignee: International Business Machines Corporation, Armonk, NY (US)

(21) Appl. No.: 18/103,007

(22) Filed: Jan. 30, 2023

(51) Int. Cl. G06N 3/08; H04L 9/00

(52) U.S. Cl. CPC G06N 3/08; H04L 9/008

(57) ABSTRACT

A trained neural network is partitioned into a client-side portion and a server-side portion, the client-side portion comprising a first set of layers of the trained neural network, the server-side portion comprising a second set of layers of the trained neural network, the trained neural network trained using a first set of training data. From a homomorphically encrypted intermediate result input to the server-side portion, a homomorphically encrypted output of the trained neural network is computed, the homomorphically encrypted intermediate result comprising a homomorphically encrypted output computed by the client-side portion.

### BACKGROUND

The present invention relates generally to a method, system, and computer program product for neural network inference. More particularly, the present invention relates to a method, system, and computer program product for neural network inference under homomorphic encryption.

An artificial neural network, or neural network, is a set of connected units called artificial neurons, in which each connection between neurons can transmit a signal to another neuron. The receiving neuron processes the signal(s) and optionally signals downstream neurons connected to it. Neurons typically have state, generally represented by real numbers (e.g., between 0 and 1). Neurons and synapses often have a weight that varies as learning proceeds, altering the strength of the signal a neuron sends downstream. Typically, neurons are organized in layers. Different layers may perform different kinds of transformations on their inputs. Signals travel from the first (input), to the last (output) layer, possibly after traversing the layers multiple times. A deep neural network is an artificial neural network with at least one layer between the input and output layers. Inference refers to processing an input through a trained neural network, thus using the neural network to infer a result or prediction. A trained neural network has a predictive accuracy, or inference accuracy, which refers to a percentage of outputs of the neural network that are considered correct by some measure. For example, if a neural network trained to classify images classifies images into the correct category 95% of the time, the neural network has an inference accuracy of 95%.

Homomorphic Encryption (HE) is a mathematical construct that allows an entity to perform computation on encrypted data without decrypting it. Plaintext refers to data that is unencrypted, and ciphertext refers to an encrypted form of a plaintext. Rotation of a ciphertext, and multiplication and addition between two ciphertexts (or ciphertext and plaintext), can be performed under HE without decryption. HE is often used to encrypt objects such as images, audio, movies, and the like for secure transmission, storage, additional computation while still encrypted.

HE is often used in a client-server environment, in which a client sends an object to a server for computation of a function on the object. The server computes the function and returns the result to the client. If the client does not want to disclose the object and the server does not want to disclose the function, the client can encrypt the object with HE and send the encrypted object to the server. The server computes the function on the encrypted object (under HE) and returns the encrypted result to the client. The client decrypts the encrypted result to obtain an unencrypted result. For example, an image classification server might include a neural network trained to classify X-ray images as COVID-19 or pneumonia. The neural network might have been trained with non-public data, or have other requirements to protect the network from disclosure or alteration, and thus should not be disclosed to others. As well, a client might want to send X-ray images for classification, without disclosing the images themselves. Thus, the client encrypts the X-ray image under HE and send the encrypted image to the server. The server classifies the encrypted image, without decrypting it, and return the encrypted classification result to the client. The client decrypts the encrypted classification result. Typically, the server includes faster or more processors, or both, than the client.

### SUMMARY

The illustrative embodiments provide a method, system, and computer program product. An embodiment includes a method that partitions, into a client-side portion and a server-side portion, a trained neural network, the client-side portion comprising a first set of layers of the trained neural network, the server-side portion comprising a second set of layers of the trained neural network, the trained neural network trained using a first set of training data. An embodiment computes, from a homomorphically encrypted intermediate result input to the server-side portion, a homomorphically encrypted output of the trained neural network, the homomorphically encrypted intermediate result comprising a homomorphically encrypted output computed by the client-side portion.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for neural network inference under homomorphic encryption in accordance with an illustrative embodiment;

FIG. 3 depicts an example of a decision tree used in an example configuration for neural network inference under homomorphic encryption in accordance with an illustrative embodiment;

FIG. 4 depicts an example of pseudocode and tables used in neural network inference under homomorphic encryption in accordance with an illustrative embodiment;

FIG. 5 depicts an example of neural network inference under homomorphic encryption in accordance with an illustrative embodiment;

FIG. 6 depicts a flowchart of an example process for neural network inference under homomorphic encryption in accordance with an illustrative embodiment.

### DETAILED DESCRIPTION

The illustrative embodiments recognize that HE operations require significantly more time to perform than their plaintext counterparts. For example, under one popular HE scheme called Homomorphic Encryption for Arithmetic of Approximate Numbers (HEAAN) under full Residual Number System (RNS), addition and multiplication operations between ciphertexts take 50× and 2,500×, respectively, more time than if they were plaintext. The ciphertext starts out with some noise, added for security reasons, and the noise grows as operations are subsequently performed on the ciphertext. The limit of the number of chained operations that can be performed on the ciphertext is defined by a parameter called the multiplicative depth. If an operation is performed beyond the multiplicative depth, the noise in the ciphertext makes the ciphertext un-decryptable, unless an operation called bootstrap (costly in terms of computation time and the number of operations) is used. While the multiplicative depth of the HE scheme is programmable, the size of the generated ciphertext and number of sub-operations needed to be performed per operation are proportional to the multiplicative depth. The illustrative embodiments recognize that one can reduce the size of the ciphertext, and thus the cost of HE operations, by selecting a lower multiplicative depth parameter for the scheme and limiting the number of chained operations. As well, neural networks typically include multiple layers, and most layers include non-polynomial activation functions that are approximated by high-degree polynomials in HE, thus increasing the multiplicative depth requirement of the algorithm. As a result, one way to reduce the number of HE operations necessary in performing neural network inferences under HE is to reduce the number of neural network layers performing computations under HE and instead compute some neural network layers in the plaintext form.

The illustrative embodiments also recognize that HE-encrypted data requires significantly more storage space than plaintext versions of the same data. For example, the HEAAN scheme converts an input message consisting of n complex numbers (n pairs of doubles) to a polynomial of degree N−1 with N coefficients, where each coefficient is bounded by an integer q (max. Q). The choice of these parameters is determined by the multiplicative depth of the circuit. Using the default values of these parameters, the data expansion (ratio of size of the encoded message to input message) can be up to 100,000 times. Further, when encrypting an image with HE, image compression formats are not usable. Instead, the pixels of the image must be encrypted into ciphertexts that are polynomials with approximately thousand-bit coefficients, yielding an encrypted representation of the image that requires significantly larger storage space or communication time than is the case for the original image. Thus, the illustrative embodiments recognize that there is a need to reduce the amount of HE-encrypted data transmitted to a server for processing under HE.

The illustrative embodiments recognize that a neural network might have been trained with non-public data, or have other requirements to protect the network from disclosure or alteration, and thus should not be disclosed to others. However, a network trained with non-public, or confidential, data typically has an improved inference accuracy compared to a network trained with public data. In addition, a system on which a trained neural network is implemented typically processes data more quickly than a system supplying data to be processed. Thus, there is a need to perform at least some portion of neural network inference under HE, in a manner that does not risk disclosure of non-public information and reduces neural network inference time as much as possible.

Thus, the illustrative embodiments recognize that there is a need to reduce overall neural network processing time to perform inferences on HE data, and reduce the amount of HE-encrypted data transmitted to a server for processing under HE, while still protecting non-public neural network training data from exposure.

The illustrative embodiments recognize that the presently available tools or solutions do not address these needs or provide adequate solutions for these needs. The illustrative embodiments used to describe the invention generally address and solve the above-described problems and other problems related to neural network inference under homomorphic encryption.

An embodiment can be implemented as a software application. The application implementing an embodiment can be configured as a modification of an existing neural network inference system, as a separate application that operates in conjunction with an existing neural network inference system, a standalone application, or some combination thereof.

Particularly, some illustrative embodiments provide a method that partitions, into a client-side portion and a server-side portion, a trained neural network and computes, from a homomorphically encrypted intermediate result computed by the client-side portion, a homomorphically encrypted output of the trained neural network.

Herein, a server refers to a computer system that performs neural network inference under homomorphic encryption, on data received from another computer system. Herein, a client refers to a computer system that sends homomorphically encrypted data to a server for neural network inference under homomorphic encryption. The terms client and server refer only to whether or not neural network inference under homomorphic encryption is performed, regardless of other functions of the respective computer systems. An embodiment executing on a server is referred to herein as a server embodiment and an embodiment executing on a client is referred to herein as a client embodiment.

An embodiment selects a partition location, a layer number of a neural network denoted herein by L. If neural network layers are numbered from 1 (the layer closest to the input to the network) to N (the layer closest to the output of the network), the first L layers of an N-layered network (a client-side portion) are disclosed to and computed by a client in plaintext, and the remaining N-L layers (a server-side portion) are kept on a server and executed under HE. One way to reduce the number of HE operations necessary in performing neural network inferences under HE is to reduce the number of neural network layers performing computations under HE, thus reducing the computation cost of performing neural network inference under HE. In addition, in many neural network implementations the size of the feature map (the data sent from one layer to the next layer in the network) grows smaller as computation proceeds deeper into the network. For example, in image classification a neural network starts with RGB image data (e.g., an X-ray image), then each layer of the network extracts progressively higher-level features (e.g., boundaries, then geometric shapes, then groups of shapes) with correspondingly smaller feature maps. Thus, computing as many layers as possible on the client, before the partition location, lowers the amount of data needed to be transferred from the client to the server. On the other hand, later layers of a neural network typically take longer to compute than earlier layers, and thus should be computed on a faster system (assumed to be the server) rather than a slower system (assumed to be the client). In addition, the later layers of a neural network typically benefit most from training on non-public data, and thus should not be disclosed to another system. Thus, selecting an optimal partition location implements a tradeoff in relative client and server computation speeds. Unless otherwise disambiguated, either a server embodiment or a client embodiment selects a partition location and communicates the selected partition location to the other embodiment. In addition, a server embodiment, which is assumed to be the custodian of the trained neural network, communicates the client-side portion of the network to the client. If, instead, a client embodiment is the custodian of the trained neural network, the client embodiment communicates the server-side portion of the network to the server.

To select a partition location, an embodiment uses data of one or more of the server, client, the neural network to be partitioned, and the inference to be performed using the neural network, as well as any user constraints such as a minimum accuracy of the neural network inference being performed. Some non-limiting examples of data of the server and client are characteristics of the client and server hardware (e.g., memory bandwidth, clock speed, core count, and the like), bandwidth and congestion level of a network connection between client and server, the compute load on the server or client, and parameters of the HE scheme being used (e.g., ciphertext modulus or number of bits used in the encryption, corresponding to a security level). Some non-limiting examples of data of the neural network being partitioned are the depth of the network (i.e., the number of layers), types of layers, and the fraction of each layer type in the network. Some data is static (e.g., the depth of the network, the core count of the server) and is not expected to change while an embodiment is executing, while other data is dynamic and expected to change while an embodiment is executing (e.g., the compute load on the server).

One embodiment selects a partition location according to a user constraint or rule. Some non-limiting examples of a user constraint or rule are that the partition location always have a specified value (e.g., three), that the partition location implements a specified ratio of layers computed by the client to layers computed by the server (e.g., one quarter of the layers are computed by the client and three quarters of the layers are computed by the server), and that the partition location has a value that is dependent on the type of neural network being partitioned or the type of input the neural network processes.

One embodiment constructs a decision tree from the results of performing inferences on the trained neural network at various input conditions of data of one or more of the server, client, and the neural network to be partitioned and various values for the partition location L, and resulting inference speed and accuracy under sets of input conditions. A decision tree is a decision support tool that uses a tree-like model of decisions and their possible consequences to arrive at a result of a sequence of decisions. Techniques are presently available to construct a decision tree in which various input conditions are used to decide on an optimal value for the partition location L under those conditions. An optimal value for the partition location L is the value that results in as fast an inference speed as possible while still maintaining an accuracy above a threshold value. Thus, a decision tree implements a set of heuristics relating input condition ranges to corresponding partition location values.

An embodiment uses the decision tree to select a value of the partition location, given current conditions of the client, server, and neural network. For example, one embodiment uses the decision tree to determine that, if the client-server net bandwidth is greater than 10 megabits per second, the client core count is less than 2, and the fraction of two-dimensional convolution layers in the neural network is less than 0.3, the partition location should be 3 (i.e., 3 layers executed on the client, and the remaining layers executed on the server). If, instead, the client-server net bandwidth is less than 10 megabits per second and the security level of the HE implementation is less than 92, the partition location should be 8. Another embodiment communicates the decision tree and other relevant data to another embodiment, which selects a partition location, given current conditions of the client, server, and neural network, and communicates the selected partition location back to the first embodiment.

In another set of embodiments, a server embodiment fills in two tables, one for the server and one for the client, with the results of performing a set of simulations of client and server under various static input conditions at various partition locations. In particular, one server embodiment, for each value of the partition location L from 1 to N, runs simulations on a blackboxed client model on the sub-network constructed with layers 1−L, and fills in a client table with data. In one embodiment, the data includes the size of the input to the neural network, the latency of inference through the client-side layers, the memory requirement that includes the size of the model, activations and bookkeeping data, and the time to transfer the results of layer L to the server. The server embodiment, for each value of the partition location L from 0 to N−1, runs simulations on a blackboxed server model on the sub-network constructed with layers L+1 . . . N, with various values of latency, input size, and memory requirements, and fills in a server table with data. In one embodiment, the data includes the size of the input to the neural network, the latency of inference through the server-side layers, the memory requirement that includes the size of the model, activations and bookkeeping data, and the accuracy of the end-to-end inference. In one embodiment, the tables are populated from simulation results using various values of dynamic condition parameters, such as the server-client network bandwidth and the compute load on the server. Another embodiment uses a mixture of simulation results and extrapolations using analytical equations to populate the tables. For example, the data transfer time often scales proportionately with the network bandwidth.

One server embodiment uses the resulting tables to select a partition location, given the static and dynamic conditions of the client, server, neural network and the environment. Another server embodiment communicates the resulting tables and other relevant data to a client embodiment, which selects a partition location, given current conditions of the client, server, and neural network, and communicates the selected partition location back to the first embodiment.

A server embodiment uses a second set of training data to further train the server-side portion of the trained neural network, while leaving the client-side portion unchanged. In one server embodiment, the second set of training data is non-public data that should not be exposed to other parties such as the client. The further training improves the accuracy of the trained neural network as a whole.

A server embodiment determines whether, after the further training, the neural network has an accuracy that is equal to or above a threshold accuracy. If so, the partitioned neural network is ready for use. If not, a server embodiment selects a different partition location in a manner described herein, thus repartitioning the neural network, and retrains, using a third set of training data, the server-side portion of the repartitioned neural network, while leaving the client-side portion unchanged. A server embodiment repeats the repartitioning and retraining until the resulting neural network has an accuracy that is equal to or above a threshold accuracy, until the number of training iterations exceeds a threshold value, or until another completion condition is satisfied.

A client embodiment applies an unencrypted input to the client-side portion, which computes an intermediate result of the client-side portion of the neural network. If the neural network has a skip connection bypassing one or more layers and directly or through additional layers provided, as an additional input, to a deeper layer, and the skip connection crosses the partition location, a client-side embodiment computes an additional intermediate result corresponding to each skip connection. The additional intermediate result is the output of the client-side layer at the input of the skip connection, and is provided to the appropriate layer (at the output of the skip connection) of the server-side portion of the neural network. A client embodiment homomorphically encrypts the intermediate result(s), and sends the homomorphically encrypted intermediate result(s) to a server embodiment.

A server embodiment receives the homomorphically encrypted intermediate result(s) from the client embodiment and applies the homomorphically encrypted intermediate result(s) to the server-side portion. The server-side portion computes a homomorphically encrypted output of the trained neural network, and sends the homomorphically encrypted output to the client embodiment, which decrypts the output. Thus, the client embodiment benefits from faster processing on the server, while not disclosing the data being processed to the server. At the same time, the server-side portion, trained with non-public data, is not disclosed to the client, but the client benefits from the improved accuracy resulting from training with non-public data.

The manner of neural network inference under homomorphic encryption described herein is unavailable in the presently available methods in the technological field of endeavor pertaining to neural network inference. A method of an embodiment described herein, when implemented to execute on a device or data processing system, comprises substantial advancement of the functionality of that device or data processing system in partitioning, into a client-side portion and a server-side portion, a trained neural network and computing, from a homomorphically encrypted intermediate result computed by the client-side portion, a homomorphically encrypted output of the trained neural network.

The illustrative embodiments are described with respect to certain types of neural networks, neural network portions, neural network layers, training data, transmissions, thresholds, validations, responses, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

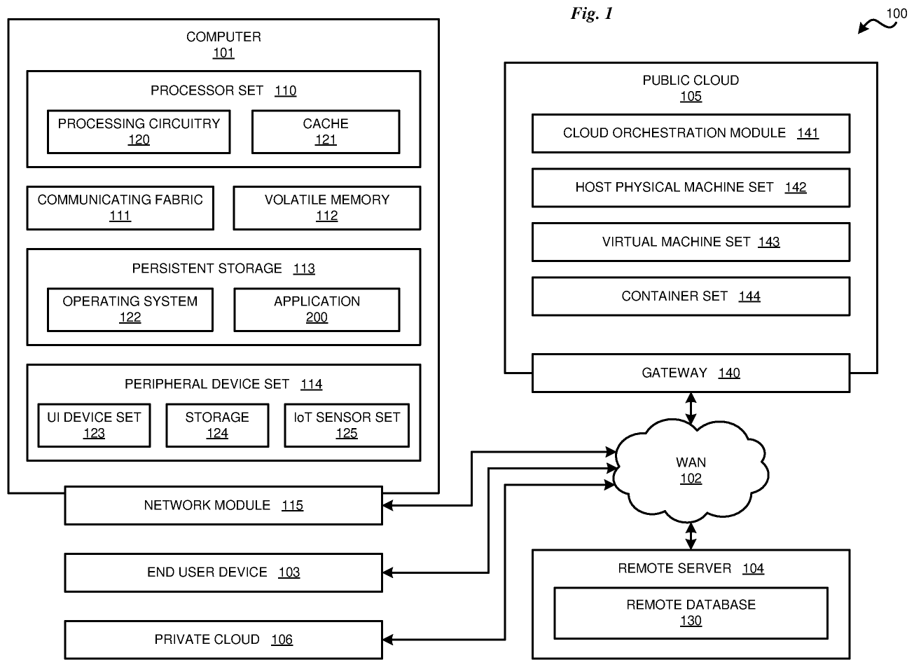

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements a neural network inference under homomorphic encryption server or client embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. A server-side implementation of application 200 and a client-side implementation of application 200 execute in any of computer 101, end user device 103, remote server 104, or a computer in public cloud 105 or private cloud 106 unless expressly disambiguated. Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single-or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144.

It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

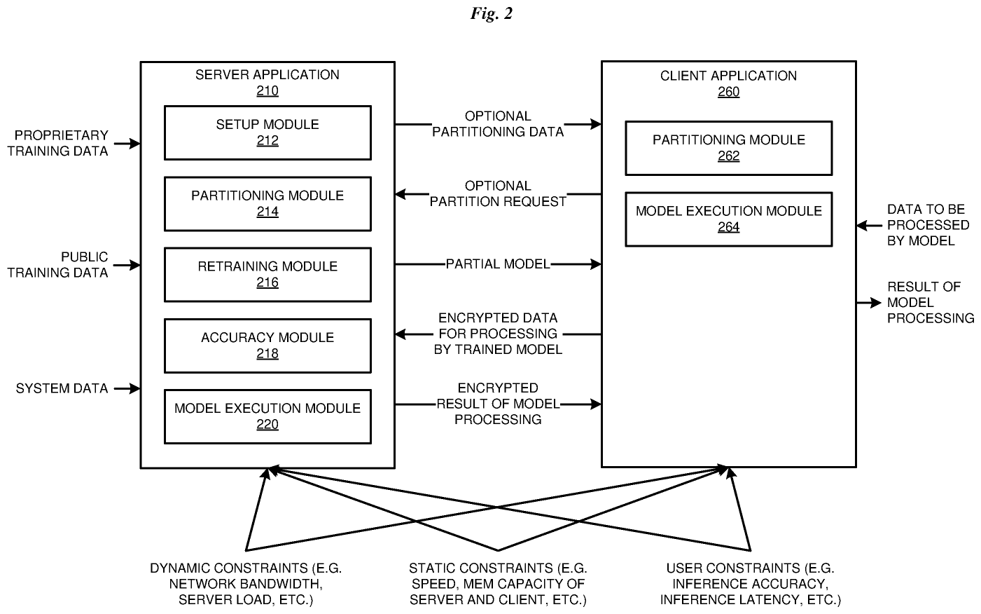

With reference to FIG. 2, this figure depicts a block diagram of an example configuration for neural network inference under homomorphic encryption in accordance with an illustrative embodiment. In particular, server application 210 and client application 260 implement server-side and client-side, respectively, implementations of application 200 in FIG. 1.

Within server application 210, partitioning module 214 selects a partition location, a layer number of a neural network denoted herein by L. If neural network layers are numbered from 1 (the layer closest to the input to the network) to N (the layer closest to the output of the network), the first L layers of an N-layered network (a client-side portion) are disclosed to and computed by a client in plaintext, and the remaining N-L layers (a server-side portion) are kept on a server and executed under HE. Server application 210 communicates the selected partition location to client application 260. Alternatively, within client application 260, partitioning module 262 selects a partition location and communicates the selected partition location to server application 210. In the configuration depicted, server application 210, which is assumed to be the custodian of the trained neural network, communicates the client-side portion of the network to client application 260.

To select a partition location, setup module 212 uses data of one or more of the server, client, the neural network to be partitioned, and the inference to be performed using the neural network, as well as any user constraints such as a minimum accuracy of the neural network inference being performed. Note that although module 212 is depicted as being implemented in server application 210, module 212 could also be implemented in client application 260 instead. Some non-limiting examples of data of the server and client are characteristics of the client and server hardware (e.g., memory bandwidth, clock speed, core count, and the like), bandwidth and congestion level of a network connection between client and server, the compute load on the server or client, and parameters of the HE scheme being used (e.g., ciphertext modulus or number of bits used in the encryption, corresponding to a security level). Some non-limiting examples of data of the neural network being partitioned are the depth of the network (i.e., the number of layers), types of layers, and the fraction of each layer type in the network. Some data is static (e.g., the depth of the network, the core count of the server), while other data is expected to change (e.g., the compute load on the server).

One implementation of module 212 selects a partition location according to a user constraint or rule. Some non-limiting examples of a user constraint or rule are that the partition location always have a specified value (e.g., three), that the partition location implements a specified ratio of layers computed by the client to layers computed by the server (e.g., one quarter of the layers are computed by the client and three quarters of the layers are computed by the server), and that the partition location has a value that is dependent on the type of neural network being partitioned or the type of input the neural network processes.

One implementation of module 212 constructs a decision tree from the results of performing inferences on the trained neural network at various input conditions of data of one or more of the server, client, and the neural network to be partitioned and various values for the partition location L, and resulting inference speed and accuracy under sets of input conditions. A decision tree is a decision support tool that uses a tree-like model of decisions and their possible consequences to arrive at a result of a sequence of decisions. Techniques are presently available to construct a decision tree in which various input conditions are used to decide on an optimal value for the partition location L under those conditions. An optimal value for the partition location L is the value that results in as fast an inference speed as possible while still maintaining an accuracy above a threshold value. Thus, a decision tree implements a set of heuristics relating input condition ranges to corresponding partition location values.

One implementation of partitioning module 214 or 262 uses the decision tree to select a value of the partition location, given current conditions of the client, server, and neural network. For example, one implementation of modules 214 or 262 uses the decision tree to determine that, if the client-server net bandwidth is greater than 10 megabits per second, the client core count is less than 2, and the fraction of two-dimensional convolution layers in the neural network is less than 0.3, the partition location should be 3 (i.e., 3 layers executed on the client, and the remaining layers executed on the server). If, instead, the client-server net bandwidth is less than 10 megabits per second and the security level of the HE implementation is less than 92, the partition location should be 8. In one implementation, module 214 communicates the decision tree and other relevant data to module 262, which selects a partition location, given current conditions of the client, server, and neural network, and communicates the selected partition location back to module 214. In another implementation, module 262 communicates the decision tree and other relevant data to module 214, which selects a partition location, given current conditions of the client, server, and neural network, and communicates the selected partition location back to module 262.

Another implementation of module 212 fills in two tables, one for the server and one for the client, with the results of performing a set of simulations of client and server under various static input conditions at various partition locations. In particular, one implementation of module 212, for each value of the partition location L from 1 to N, runs simulations on a blackboxed client model on the sub-network constructed with layers 1−L, and fills in a client table with data. In one implementation, the data includes the size of the input to the neural network, the latency of inference through the client-side layers, the memory requirement that includes the size of the model, activations and bookkeeping data, and the time to transfer the results of layer L to the server. The implementation, for each value of the partition location L from 0 to N−1, runs simulations on a blackboxed server model on the sub-network constructed with layers L+1 . . . N, with various values of latency, input size, and memory requirements, and fills in a server table with data. In one implementation, the data includes the size of the input to the neural network, the latency of inference through the server-side layers, the memory requirement that includes the size of the model, activations and bookkeeping data, and the accuracy of the end-to-end inference. In one implementation of module 212, the tables are populated from simulation results using various values of dynamic condition parameters, such as the server-client network bandwidth and the compute load on the server. Another implementation of module 212 uses a mixture of simulation results and extrapolations using analytical equations to populate the tables.

One implementation of partitioning module 214 uses the resulting tables to select a partition location, given the static and dynamic conditions of the client, server, neural network, and the environment. In another implementation, partitioning module 214 communicates the resulting tables and other relevant data to partitioning module 262, which selects a partition location, given current conditions of the client, server, and neural network, and communicates the selected partition location back to partitioning module 214.

Retraining module 216 uses a second set of training data to further train the server-side portion of the trained neural network, while leaving the client-side portion unchanged. In one implementation of module 216, the second set of training data is non-public data that should not be exposed to other parties such as the client. The further training improves the accuracy of the trained neural network as a whole.

Accuracy module 218 determines whether, after the further training, the neural network has an accuracy that is equal to or above a threshold accuracy. If so, the partitioned neural network is ready for use. If not, module 216 selects a different partition location in a manner described herein, thus repartitioning the neural network, and retrains, using a third set of training data, the server-side portion of the repartitioned neural network, while leaving the client-side portion unchanged. Module 216 repeats the repartitioning and retraining until module 218 determines that the resulting neural network has an accuracy that is equal to or above a threshold accuracy, until the number of training iterations exceeds a threshold value, or until another completion condition is satisfied.

Model execution module 264 applies an unencrypted input to the client-side portion, which computes an intermediate result of the client-side portion of the neural network. If the neural network has a skip connection bypassing one or more layers and directly or through additional layers provided, as an additional input, to a deeper layer, and the skip connection crosses the partition location, module 264 computes an additional intermediate result corresponding to each skip connection. The additional intermediate result is the output of the client-side layer at the input of the skip connection, and is provided to the appropriate layer (at the output of the skip connection) of the server-side portion of the neural network. Module 264 homomorphically encrypts the intermediate result(s), and sends the homomorphically encrypted intermediate result(s) to server application 210.

Module execution module 220 receives the homomorphically encrypted intermediate result(s) from client application 260 and applies the homomorphically encrypted intermediate result(s) to the server-side portion. In module 220, the server-side portion computes a homomorphically encrypted output of the trained neural network. Module 220 sends the homomorphically encrypted output to client application 260, which decrypts the output.

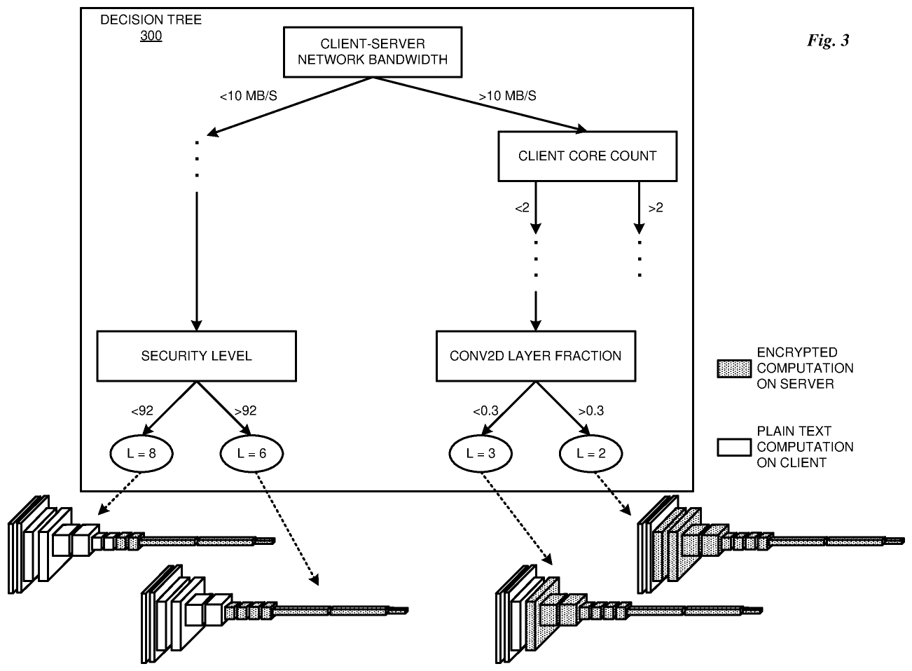

With reference to FIG. 3, this figure depicts an example of a decision tree used in an example configuration for neural network inference under homomorphic encryption in accordance with an illustrative embodiment. The example can be executed using application 210 or 260 in FIG. 2.

In particular, decision tree 300 depicts a portion of an example decision tree used to select a partition location. For example, one embodiment uses the decision tree to determine that, if the client-server net bandwidth is greater than 10 megabits per second, the client core count is less than 2, and the fraction of two-dimensional convolution layers in the neural network (Conv2D fraction) is less than 0.3, the partition location should be 3 (i.e., 3 layers executed on the client, and the remaining layers executed on the server). If, instead, the client-server net bandwidth is less than 10 megabits per second and the security level of the HE implementation is less than 92, the partition location should be 8. Partitioned neural network diagrams graphically depict the results of various values of L.

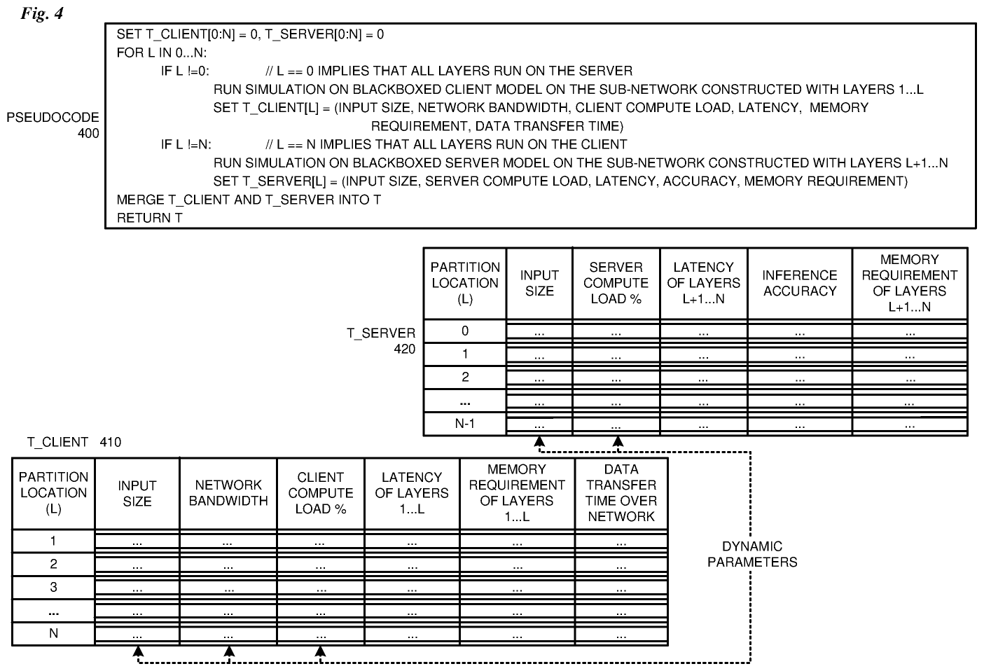

With reference to FIG. 4, this figure depicts an example of pseudocode and tables used in neural network inference under homomorphic encryption in accordance with an illustrative embodiment. The example can be executed using application 210 or 260 in FIG. 2.

Pseudocode 400 fills in two tables, T_client 410 and T_server 420, with the results of performing a set of simulations of client and server under various static input conditions at various partition locations. In particular, pseudocode 400, for each value of the partition location L from 1 to N, runs simulations on a blackboxed client model on the sub-network constructed with layers 1 . . . L, with various values of latency, input size, and memory requirements, and fills in T_client 410 with the results. Pseudocode 400, for each value of the partition location L from 0 to N−1, runs simulations on a blackboxed server model on the sub-network constructed with layers L+1 . . . N, with various values of latency, input size, and memory requirements, and fills in T_server 420 with the results. FIG. 4 also depicts examples of dynamic condition parameters, such as the server-client network bandwidth and the compute load on the server and client.

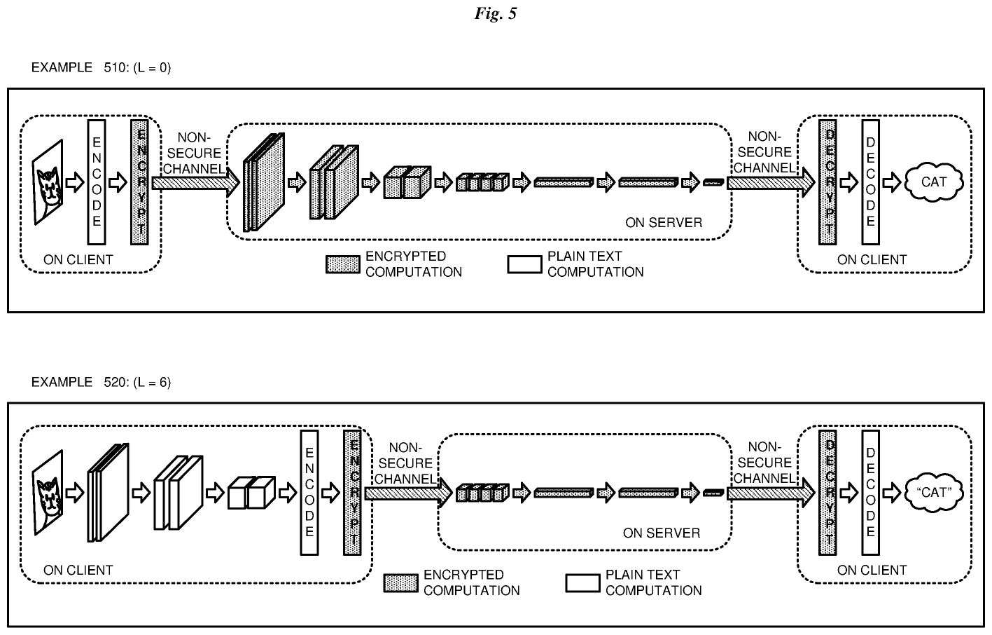

With reference to FIG. 5, this figure depicts an example of neural network inference under homomorphic encryption in accordance with an illustrative embodiment. The example can be executed using application 210 or 260 in FIG. 2.

Example 510, in which the partition location L is set to 0, depicts neural network inference of an image of a cat. Client application 260 homomorphically encrypts the image. Because the partition location is 0, the encrypted image is the intermediate result. Thus, client application 260 sends the encrypted image to application 210, which computes a homomorphically encrypted output of the trained neural network, and sends the homomorphically encrypted output to the client embodiment, which decrypts the output, thus determining that the image is one of a cat.

Example 520, in which the partition location L is set to 6, also depicts neural network inference of an image of a cat. Client application 260 homomorphically encrypts the image, and computes an intermediate result of the client-side portion of the neural network (the first 6 layers). Client application 260 homomorphically encrypts and sends the encrypted intermediate result to application 210, which computes a homomorphically encrypted output of the server-side portion of trained neural network, and sends the homomorphically encrypted output to the client embodiment, which decrypts the output, thus determining that the image is one of a cat.

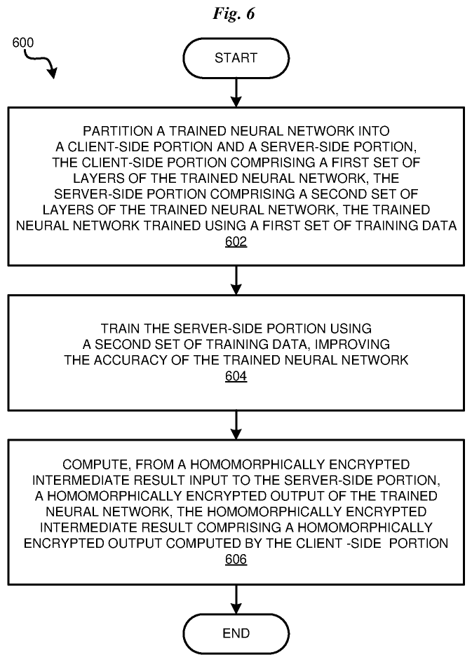

With reference to FIG. 6, this figure depicts a flowchart of an example process for neural network inference under homomorphic encryption in accordance with an illustrative embodiment. Process 600 can be implemented in application 210 in FIG. 2.

In block 602, the application partitions a trained neural network into a client-side portion and a server-side portion, the client-side portion comprising a first set of layers of the trained neural network, the server-side portion comprising a second set of layers of the trained neural network, the trained neural network trained using a first set of training data. In block 604, the application further trains, using a second set of training data, the server-side portion, the further training resulting in a further trained neural network with an improved accuracy from an accuracy of the trained neural network. In block 606, the application computes, from a homomorphically encrypted intermediate result input to the server-side portion, a homomorphically encrypted output of the trained neural network, the homomorphically encrypted intermediate result comprising a homomorphically encrypted output computed by the client-side portion. Then the application ends.

Thus, a computer implemented method, system or apparatus, and computer program product are provided in the illustrative embodiments for neural network inference under homomorphic encryption and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

What is claimed is:

1. A computer-implemented method comprising:
partitioning, into a client-side portion and a server-side portion, a trained neural network, the client-side portion comprising a first set of layers of the trained neural network, the server-side portion comprising a second set of layers of the trained neural network, the trained neural network trained using a first set of training data; and
computing, from a homomorphically encrypted intermediate result input to the server-side portion, a homomorphically encrypted output of the trained neural network, the homomorphically encrypted intermediate result comprising a homomorphically encrypted output computed by the client-side portion.

2. The computer-implemented method of claim 1, wherein the partitioning is performed using a received partition location.

3. The computer-implemented method of claim 1, wherein the partitioning is performed using a partition location computed using data of a system computing the homomorphically encrypted output of the trained neural network.

4. The computer-implemented method of claim 3, wherein the partition location is computed using static data of the system computing the homomorphically encrypted output of the trained neural network.

5. The computer-implemented method of claim 3, wherein the partition location is computed using dynamic data of the system computing the homomorphically encrypted output of the trained neural network.

6. The computer-implemented method of claim 1, further comprising:
further training, using a second set of training data, the server-side portion, the further training resulting in a further trained neural network with an improved accuracy from an accuracy of the trained neural network.

7. The computer-implemented method of claim 6, wherein the first set of training data is public and the second set of training data is nonpublic.

8. The computer-implemented method of claim 6, further comprising:
second partitioning, into a second client-side portion and a second server-side portion, the further trained neural network, wherein the second client-side portion has a different number of layers from the client-side partition, wherein the second partitioning is performed responsive to determining that an accuracy of the further trained neural network is less than a threshold accuracy; and
retraining, using a third set of training data, the second server-side portion, the retraining resulting in an accuracy improvement from the further trained neural network.

9. The computer-implemented method of claim 1, wherein the homomorphically encrypted intermediate result is computed by the client-side portion in an unencrypted form and subsequently homomorphically encrypted.

10. A computer program product comprising one or more computer readable storage medium, and program instructions collectively stored on the one or more computer readable storage medium, the program instructions executable by a processor to cause the processor to perform operations comprising:
partitioning, into a client-side portion and a server-side portion, a trained neural network, the client-side portion comprising a first set of layers of the trained neural network, the server-side portion comprising a second set of layers of the trained neural network, the trained neural network trained using a first set of training data; and
computing, from a homomorphically encrypted intermediate result input to the server-side portion, a homomorphically encrypted output of the trained neural network, the homomorphically encrypted intermediate result comprising a homomorphically encrypted output computed by the client-side portion.

11. The computer program product of claim 10, wherein the stored program instructions are stored in a computer readable storage device in a data processing system, and wherein the stored program instructions are transferred over a network from a remote data processing system.

12. The computer program product of claim 10, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

13. The computer program product of claim 10, wherein the partitioning is performed using a received partition location.

14. The computer program product of claim 10, wherein the partitioning is performed using a partition location computed using data of a system computing the homomorphically encrypted output of the trained neural network.

15. The computer program product of claim 14, wherein the partition location is computed using static data of the system computing the homomorphically encrypted output of the trained neural network.

16. The computer program product of claim 14, wherein the partition location is computed using dynamic data of the system computing the homomorphically encrypted output of the trained neural network.

17. The computer program product of claim 10, further comprising:
further training, using a second set of training data, the server-side portion, the further training resulting in a further trained neural network with an improved accuracy from an accuracy of the trained neural network.

18. The computer program product of claim 17, wherein the first set of training data is public and the second set of training data is nonpublic.

19. The computer program product of claim 17, further comprising:
second partitioning, into a second client-side portion and a second server-side portion, the further trained neural network, wherein the second client-side portion has a different number of layers from the client-side partition, wherein the second partitioning is performed responsive to determining that an accuracy of the further trained neural network is less than a threshold accuracy; and
retraining, using a third set of training data, the second server-side portion, the retraining resulting in an accuracy improvement from the further trained neural network.

20. A computer system comprising a processor and one or more computer readable storage media, and program instructions collectively stored on the one or more computer readable storage media, the program instructions executable by the processor to cause the processor to perform operations comprising:
partitioning, into a client-side portion and a server-side portion, a trained neural network, the client-side portion comprising a first set of layers of the trained neural network, the server-side portion comprising a second set of layers of the trained neural network, the trained neural network trained using a first set of training data; and
computing, from a homomorphically encrypted intermediate result input to the server-side portion, a homomorphically encrypted output of the trained neural network, the homomorphically encrypted intermediate result comprising a homomorphically encrypted output computed by the client-side portion.
